(19) United States
(12) Patent Application Publication
(10) Pub. No.: US 2009/0032997 A1
(43) Pub. Date: Feb. 5, 2009

(54) Resin pattern formation method

(75) Inventor: Kenji Hiratsuka, Yokohama-shi (JP)

Correspondence Address: SMITH, GAMBRELL & RUSSELL, 1130 CONNECTICUT AVENUE, N.W., SUITE 1130, WASHINGTON, DC, 20036, US

(73) Assignee: SUMITOMO ELECTRIC INDUSTRIES, LTD.

(21) Appl. No.: 12/222,045

(22) Filed: Jul. 31, 2008

(30) Foreign Application Priority Data
Aug. 2, 2007 (JP) P2007-202158

(51) Int. Cl. B28B 11/08

(52) U.S. Cl. 264/293

(57) ABSTRACT

The present invention provides a resin pattern formation method. When a mold 10 is pressed against a substrate 20, a spacer portion 14 that it is taller than a protrusion portion 12, makes contact with the substrate 20. As a result, regardless of the density of the protrusion pattern 12, uniform loading can be realized. Consequently, the desired resin pattern 30A can be obtained with high precision, and high production yields can be attained.

### BACKGROUND OF THE INVENTION

1. Field of the Invention

The present invention relates to a resin pattern formation method using a nanoimprint lithography method.

2. Related Background Art

In recent years, research has been conducted on methods of forming micro-patterns on substrate surfaces using nanoimprint lithography methods. Nanoimprint lithography methods are for example disclosed in Non-patent References 1 and 2 below.

In general, nanoimprint lithography is performed according to the procedure shown in FIG. 10. That is, as shown in (a) of FIG. 10, first a monomer resin 130 is spin-coated to uniform thickness onto the surface of a substrate 120 placed on a stage S. Next, as shown in (b) of FIG. 10, a mold 110 in which a transfer pattern is formed is pressed gradually against the substrate 120, while being held by a head H so as to be parallel to the substrate 120. Then, with the mold 110 pressed against the substrate 120, heat, light, or other means is used to harden the resin 130 on the substrate surface. Finally, as shown in (c) of FIG. 10, the head H is raised, and the mold 110 is separated from the substrate 120, to complete formation of a pattern 130A on the substrate surface by the nanoimprint lithography method.

In such patterning formation, the substrate 120 and mold 110 must be kept parallel with high precision in order to realize high production yields. Hence research is being performed on technology to make the substrate 120 and mold 110 parallel by bringing each of tip portions of the protrusion pattern of the mold 110 into contact with the substrate surface.

[Non-patent Reference 1]: S. Y Chou, P. R. Krauss and P. J. Renstrom, “Imprint of sub-25 nm vias and trenches in polymers”, Applied Physics Letters, Vol. 67, 1995, pp. 3114-3116.

[Non-patent Reference 2]: S. Y Chou, P. R. Krauss and P. J. Renstrom, “Nanoimprint Lithography”, J. Vac. Sci. Technol., Vol. B14, 1996, pp. 4129-4133.

### SUMMARY OF THE INVENTION

In the above-described resin pattern formation methods of the prior art, there is the following problem. That is, when the mold is brought into close contact with the substrate such that the tip portions of the pattern of the mold are brought into contact with the substrate surface, because in general the density of the pattern differs among regions, attainment of uniform loading is extremely difficult, and so production yields tend to decline.

This invention was devised in order to resolve the above problem, and has as an object the provision of a resin pattern formation method which improves production yields.

A resin pattern formation method of this invention is a resin pattern formation method of forming a resin pattern on a substrate using a nanoimprint lithography method, and comprises a process of covering the surface of the substrate with a resin which is to become the resin pattern; a process of pressing a mold, whose surface opposite to the substrate has a protrusion pattern and a spacer portion taller than the protrusion pattern, against the substrate, and bringing the spacer portion into contact with the substrate; a process of hardening the resin in the state in which the mold is pressed against the substrate; and a process of separating the mold from the substrate, to obtain the resin pattern.

In this resin pattern formation method, when the mold is pressed against the substrate, a spacer portion higher than the protrusion pattern comes into contact with the substrate. As a result, regardless of the density of the protrusion pattern, uniform loading is attained. As a result, the desired resin pattern can be obtained with high precision, and high production yields can be realized. In addition, because there is no need to bring the protrusion pattern into contact with the substrate, there is greater freedom in setting the pattern depth.

Further, a mode may be employed in which a plurality of spacer portions are provided on the periphery of the protrusion pattern, and a mode may be employed in which a spacer portion is provided in an annular shape surrounding the periphery of the protrusion pattern.

Further, a mode may be employed in which a plurality of pattern formation regions, in which the protrusion pattern is formed, are provided in the mold, and spacer portions are provided so as to be interposed between the pattern formation regions.

By means of this invention, a resin pattern formation method is provided with improved production yields.

### BRIEF DESCRIPTION OF THE DRAWINGS

FIG. 1 shows a mold in an embodiment of the invention, in which (a) is a plane view, and (b) is a cross-sectional view along line α-α in (a);

FIG. 2 shows a protrusion pattern formed in the mold of FIG. 1, in which (a) is a plane view, and (b) is an enlarged view of (a);

FIG. 3 shows the protrusion pattern formed on the mold of FIG. 1, in which (a) is a side view, and (b) is an enlarged view of (a);

FIG. 4 shows the substrate of an embodiment of the invention, in which (a) is a plane view, and (b) is a cross-sectional view;

FIG. 5 is a flow diagram showing the procedure to form a resin pattern on the substrate of FIG. 4, using the mold of FIG. 1;

FIG. 6 is a flow diagram showing the procedure to form a diffraction grating in a diffraction grating layer, using the resin pattern formed on the substrate of FIG. 4;

FIG. 7 is a flow diagram showing the procedure to manufacture a semiconductor laser from the multilayer substrate obtained from the procedure of the flow diagram of FIG. 6;

FIG. 8 shows an embodiment of a different aspect;

FIG. 9 shows different modes for the spacer portion of the mold;

FIG. 10 is a flow diagram showing the procedure of a resin pattern formation method of the prior art;

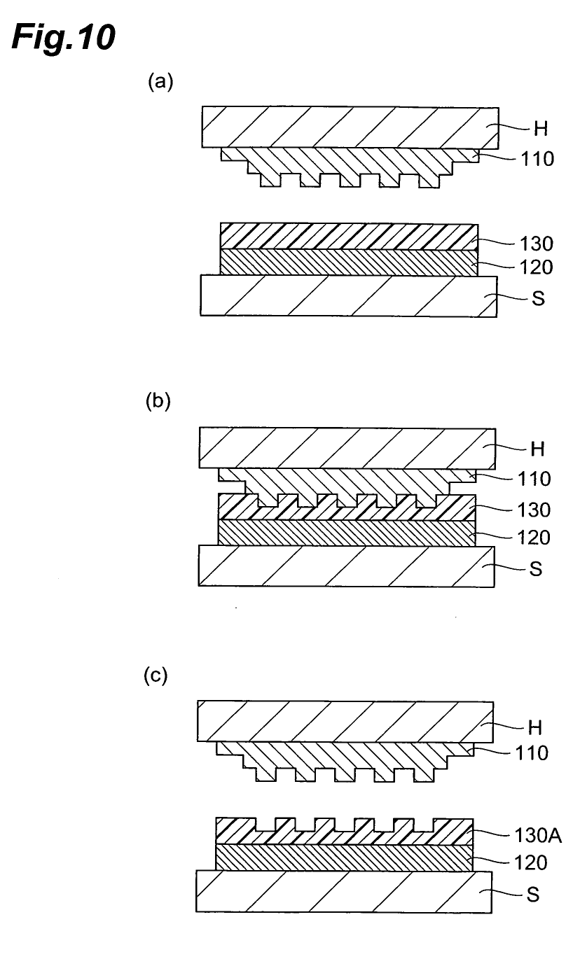

### DESCRIPTION OF THE PREFERRED EMBODIMENTS

Below, best modes for implementing the present invention are explained in detail, referring to the attached drawings. Elements which are the same or similar are assigned the same symbols, and when an explanation is redundant, the explanation is omitted.

Below, a method of manufacture of a semiconductor laser utilizing a nanoimprint lithography method is explained.

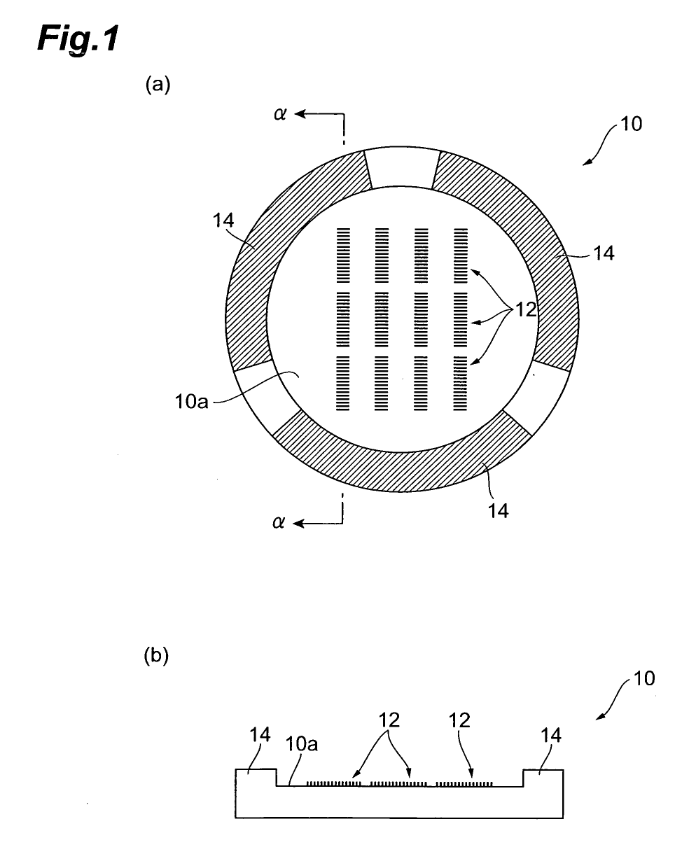

In the nanoimprint lithography method, a prescribed mold is used to form a resin pattern on a substrate; in this aspect, the mold 10 shown in FIG. 1 through FIG. 3 is used. This mold 10 is for example formed from quartz, and as shown in FIG. 1 has substantially the same shape of a circular disc.

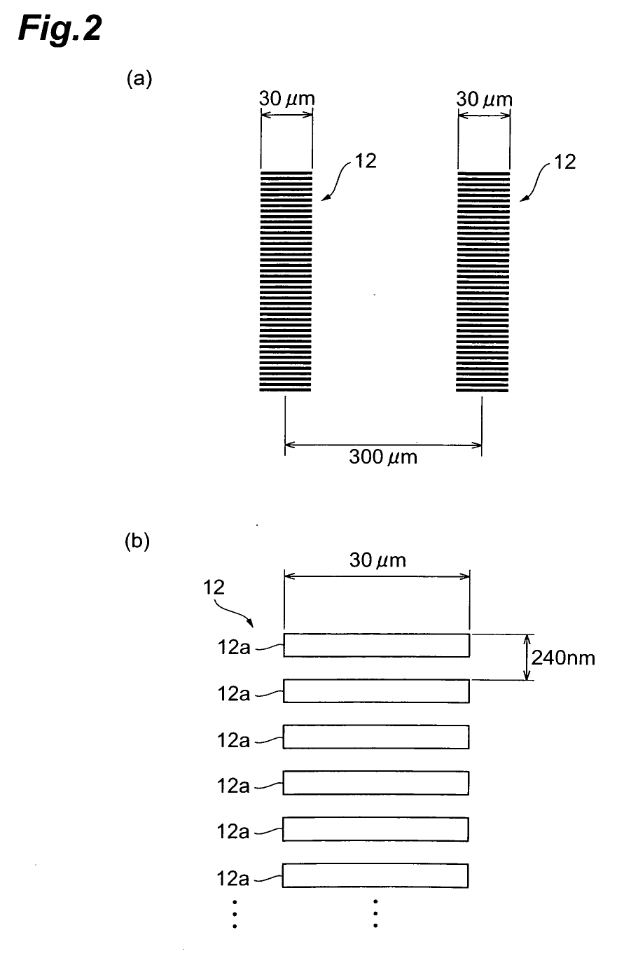

In the center region of the main surface 10a of the mold 10 are regularly positioned a plurality of protrusion patterns 12 in a matrix. Each of the protrusion patterns 12 comprises a plurality of patterns 12a, of equal length and arranged in a row, as shown in FIG. 2, and provided at intervals of approximately 300 μm. In FIG. 1, a mode is shown in which 12 sets of protrusion patterns 12 are arranged in a 3×4 matrix, but the mode of the arrangement may be modified as appropriate, and arrangement in a matrix of 100×100 is also possible.

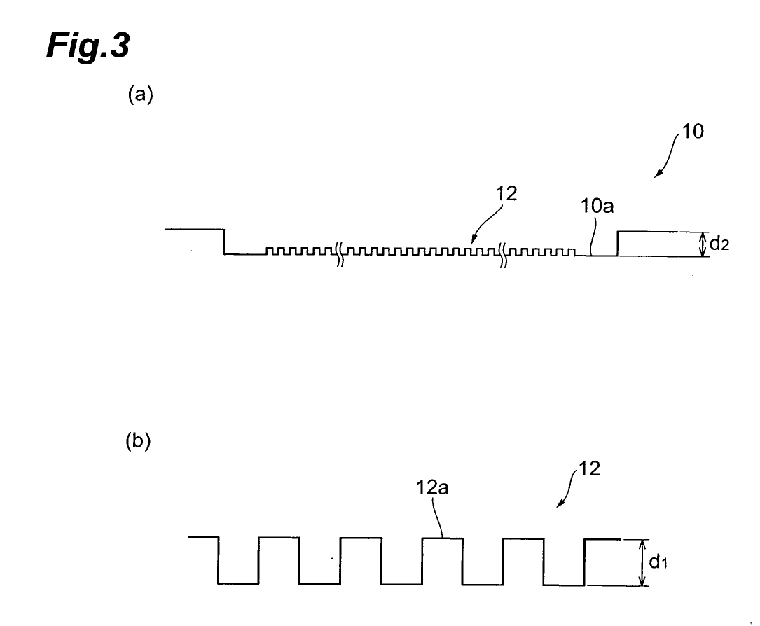

Further, the lengths of each of the patterns 12a of the protrusion pattern 12 are approximately 30 μm, and the pitch is approximately 240 nm. Also, as shown in FIG. 3, the protrusion pattern 12 is formed with a cross-section of rectangular shape, and the height (d₁) from the main surface 10a in each of the patterns 12a is the same (for example, 140 nm).

Further, on the circumferential edge portion of the mold 10 are provided three arc-shape spacer portions 14 along the periphery. The three spacer portions 14 have the same shape, and are placed at equal intervals. The heights (d₂) from the main surface 10a of each of the spacer portions 14 are equal, and are higher than the above-described pattern height d₁ of the protrusion pattern 12 (that is, d₂>d₁).

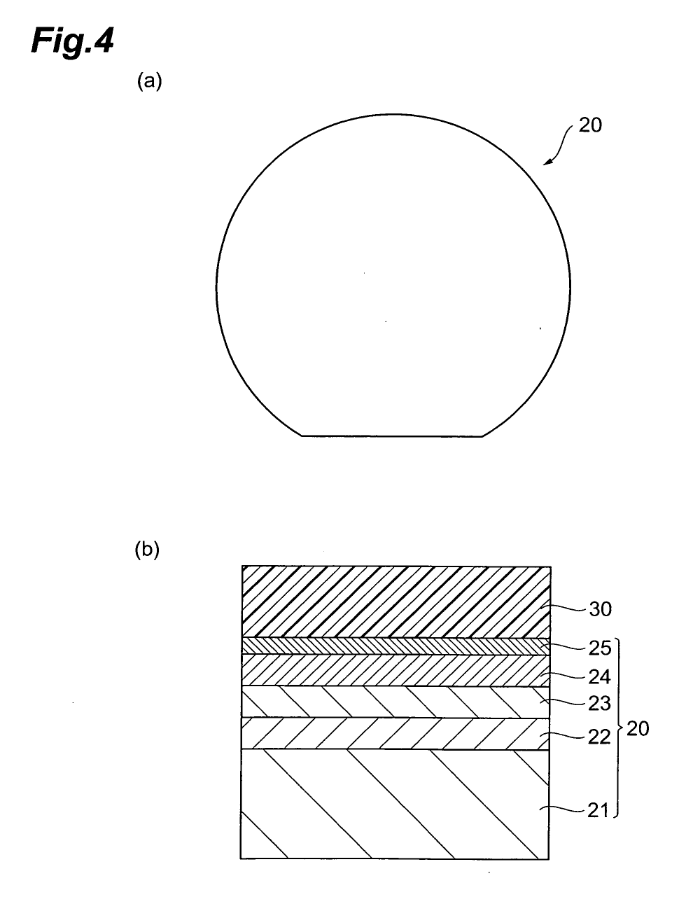

Next, a substrate 20 to be patterned using the above mold 10 is described, referring to FIG. 4.

The substrate 20 is a semiconductor epitaxial wafer having an orientation flat, with a multilayer structure comprising a plurality of semiconductor layers. Specifically, on the lowermost layer which is the InP substrate 21, in order from below, an n-type cladding layer 22, active layer 23, p-type diffraction grating layer 24, and SiO₂ layer 25 are formed in laminated structure.

The InP substrate 21 has thickness of for example 350 μm and a carrier concentration of approximately 1.0×10¹⁸ cm⁻³; the semiconductor layers 22, 23, 24 are grown by the organo-metallic vapor phase epitaxy (OMVPE) method.

The n-type cladding layer 22 is an InP layer, of thickness for example 0.55 μm and with a carrier concentration of approximately 8.0×10¹⁷ cm⁻³. The active layer 23 is a layer comprising an InGaAsP system compound semiconductor; the structure can be selected from among the structures of, for example, a single semiconductor layer, a single quantum-well structure, or a multiple quantum-well structure, as appropriate. The diffraction grating layer 24 is an InGaAsP layer in which is formed a diffraction grating, described below, and has a thickness of 0.5 μm and a carrier concentration of approximately 5.0×10¹⁷ cm⁻³.

The SiO₂ layer 25 is formed on the diffraction grating layer 24 to a thickness of 30 nm by plasma CVD.

And, when forming the resin pattern on the substrate 20, a photosensitive resin 30 is spin-coated onto the substrate 20. As this resin 30, for example, PAK-01 by Toyo Gosei Co. Ltd. can be used.

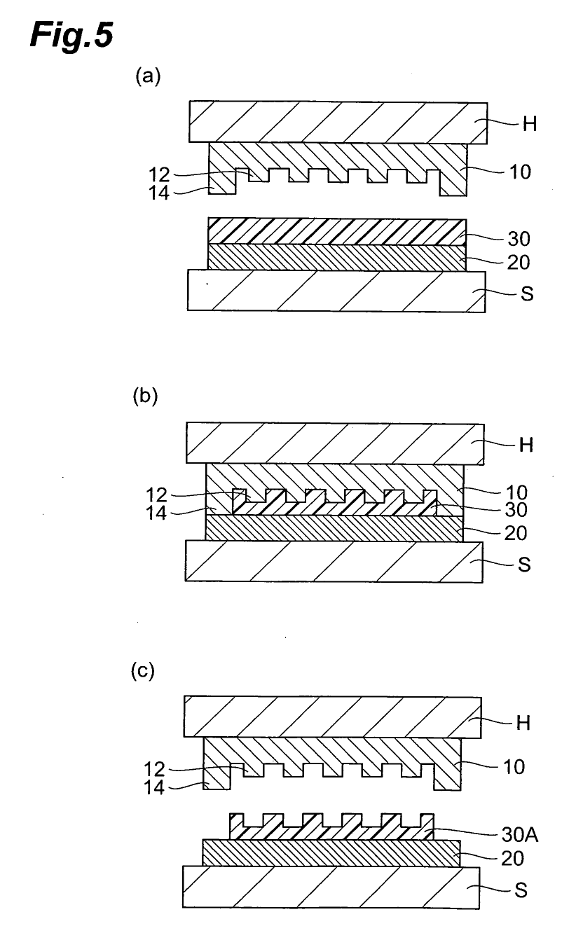

Next, the procedure of forming a resin pattern on the substrate 20 using the above-described mold 10 is explained, referring to FIG. 5.

First, as shown in (a) of FIG. 5, the substrate 20 is mounted on the stage S which conducts for nanoimprint lithography, and the mold 10 is held by the head H so as to be parallel to and opposed to the substrate 10, with the main surface 10a of the mold 10 facing the substrate 20.

Next, while holding the substrate 20 and mold 10 parallel, the head H is lowered, and as shown in (b) of FIG. 5, the mold 10 is pressed against the substrate 20 with a prescribed pressure (for example, 13 MPa). At this time, the spacer portions 14 formed in the surface (the main surface) 10a of the mold 10 on the side opposing the substrate 20 make contact with the substrate 20. Due to this pressing, the protrusion pattern 12 formed in the mold 10 is transferred to the resin 30 on the substrate 20, and a reverse pattern (a so-called negative pattern) of the protrusion pattern is formed in the upper surface of the resin 30. It is extremely difficult to making the mold 10 and substrate 20 exactly parallel through adjustment of the head H; if, in the above pressing-down process, one of the spacer portions 14 first makes contact with the substrate 20, and then the pressing pressure is increased, then all three spacer portions 14 will make contact with the substrate 20, and the mold 10 will become parallel with the substrate 20. At this time, the protrusion pattern 12 is not in contact with the substrate 20, so that mechanical damage can be avoided.

Then, with the mold 10 pressed against the substrate 20, flowing of the resin 30 around the protrusion pattern 12 of the mold 10 and stabilization of pressure is awaited, and thereafter the resin 30 is irradiated with ultraviolet rays, to cause hardening of the resin 30. By this means, a resin pattern 30A, in which the above negative pattern is formed, is obtained.

Finally, as shown in (c) of FIG. 5, the head H is raised, the mold 10 is separated from the substrate 20, and formation of a resin pattern 30A on the substrate 20 is completed.

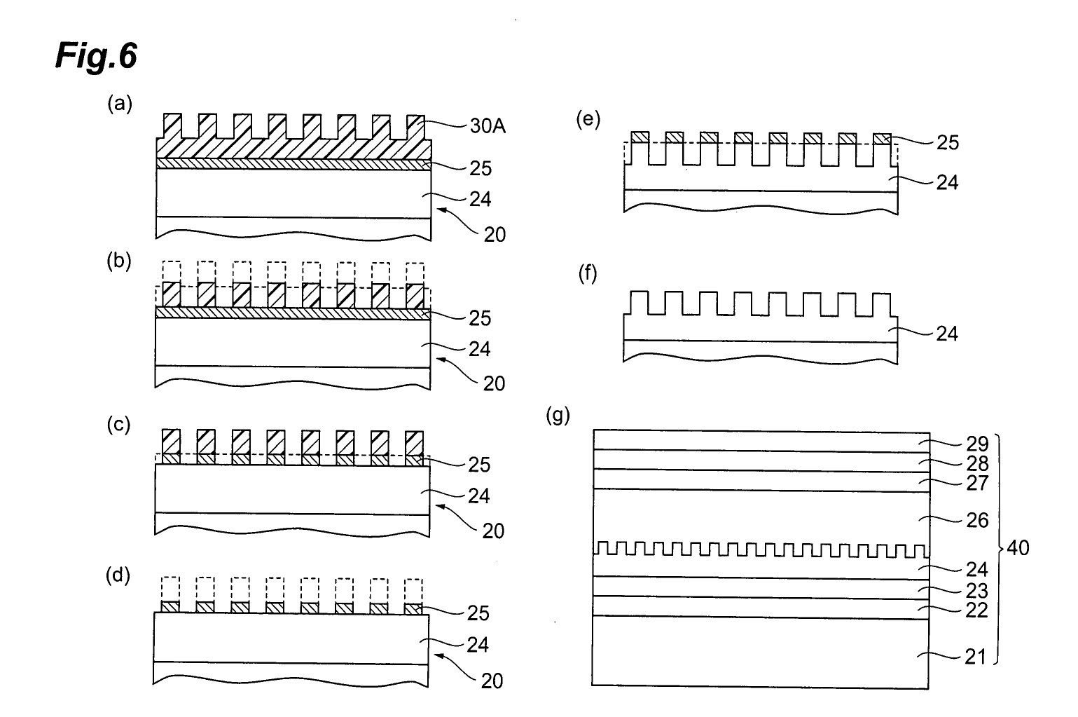

Next, a procedure for forming a diffraction grating in the diffraction grating layer 24 using the resin pattern 30A formed as explained above is described, referring to FIG. 6.

As shown in (a) of FIG. 6, after formation of the resin pattern 30A on the SiO₂ layer 25 of the substrate 20, processing is performed to remove residual film using O₂ plasma, as shown in (b) of FIG. 6, exposing the SiO₂ layer 25 in regions corresponding to depression portions of the resin pattern 30A. Then, CF₄ gas is used to perform reactive ion etching (RIE), and as shown in (c) of FIG. 6, the exposed regions of the SiO₂ layer 25 are partially removed. Then, as shown in (d) of FIG. 6, O₂ plasma is used to remove the remaining resin pattern 30A.

Next, as shown in (e) of FIG. 6, the patterned SiO₂ layer 25 is used as a mask to perform etching and removal, to a depth of 40 nm, of the diffraction grating layer 24 using methane-hydrogen gas RIE. Then, as shown in (f) of FIG. 6, the SiO₂ layer 25 used as a mask is removed with hydrofluoric acid. In addition, a mixed aqueous solution of sulfuric acid and hydrogen peroxide is used to slightly etch the surface of the diffraction grating layer 24, after which a p-type cladding layer 26, p-type cap layer 27, silicon-based inorganic insulating layer (SiO₂ layer) 28, and photosensitive resist layer 29 are formed in order.

Here, the cladding layer 26 comprises InP, and is of thickness 0.4 μm, with a carrier concentration of 8.0×10¹⁷ cm⁻³; the cap layer 27 is of InGaAs, of thickness 0.2 μm, and with a carrier concentration of 2.0×10¹⁷ cm³.

From the above, a multilayer substrate 40 is obtained, in which are layered, in order on the InP substrate 21, an n-type cladding layer 22, active layer 23, p-type diffraction grating layer 24, p-type cladding layer 26, p-type cap layer 27, inorganic insulating layer 28, and photosensitive resist layer 29.

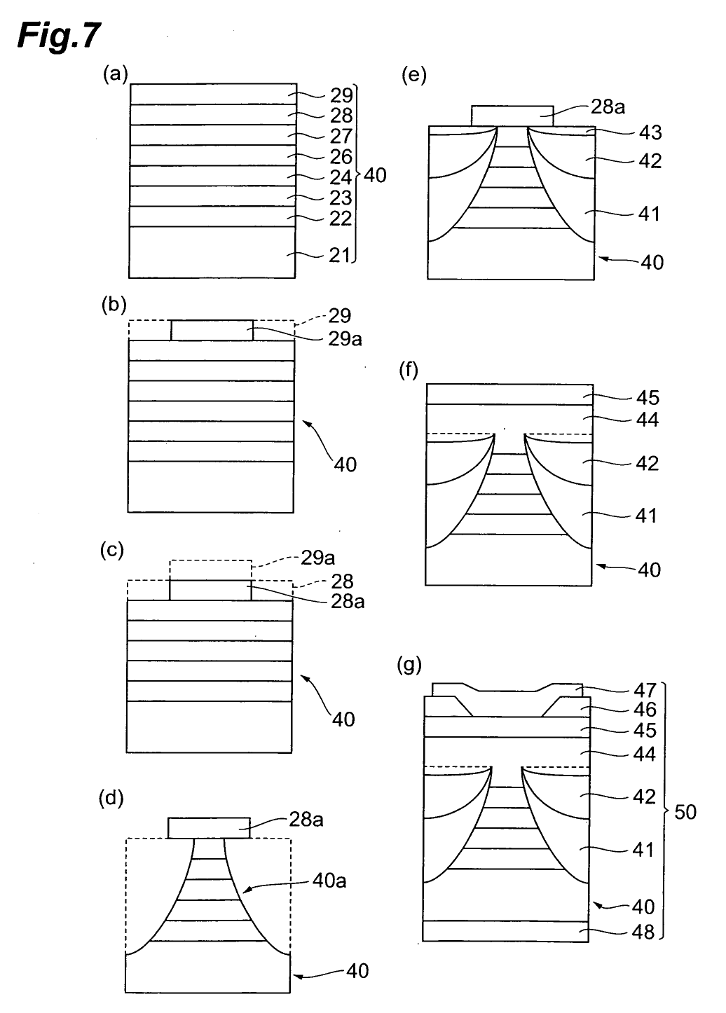

Next, the procedure for manufacture of a mesa-type semiconductor layer using the multilayer substrate 40 is explained, referring to FIG. 7.

Exposure and development of the resist layer 29 of the multilayer substrate 40 shown in (a) of FIG. 7 is performed using a photomask having a prescribed pattern, to obtain a stripe-shape resist layer 29a extending in the direction of arrangement of the diffraction grating of the diffraction grating layer 24 (see (b) of FIG. 7). Next, the stripe-shape resist layer 29a is used as a mask to perform etching of the insulating layer 28, to obtain a stripe-shape insulating layer 28a, and in addition the stripe-shape resist layer 29a is removed (see (c) of FIG. 7). Moreover, the stripe-shape insulating layer 28a is used as a mask to perform etching, using for example bromine-methanol, until the InP substrate 21 is exposed, to form a semiconductor mesa 40a (see (d) in FIG. 7).

Then, the multilayer substrate 40, on which the semiconductor mesa 40a is formed is placed in an organo-metallic vapor phase growth furnace, and the stripe-shape insulating layer 28a is used as a selective growth mask to form current-blocking layers (buried layers) 41, 42, 43 on the mesa side surfaces (see (e) of FIG. 7). These current-blocking layers are formed by means of a p-type InP layer 41, n-type InP layer 42, and p-type InP layer 43. The p-type InP layer 41 has thickness 1000 nm and carrier concentration 1.0×10¹⁸ cm⁻³, the n-type InP layer 42 has thickness 1000 nm and carrier concentration 1.8×10¹⁸ cm⁻³, and the p-type InP layer 43 has thickness 200 nm and carrier concentration 1.0×10¹⁸ cm⁻³. In the current-blocking layers 41, 42, 43, the p-type impurity is Zn, and the n-type impurity is Si.

Then, the multilayer substrate 40 is removed from the organo-metallic vapor phase growth furnace, the stripe-shape insulating layer 28a is removed using a hydrofluoric acid aqueous solution, and the cap layer 27 is selectively etched and removed using a mixed aqueous solution of phosphoric acid and hydrogen peroxide. Then, the multilayer substrate 40 is once again placed in the organo-metallic vapor phase growth furnace, and a p-type InP cladding layer 44 and p-type InGaAs contact layer 45 are grown (see (f) of FIG. 7). Here, the p-type InP cladding layer 44 has thickness 1.6 μm and a carrier concentration of 1.5×10¹⁸ cm⁻³, and the p-type InGaAs contact layer 45 has thickness 0.52 μm and a carrier concentration of 1.5×10¹⁹ cm⁻³. Growth of the current-blocking layers 41, 42, 43 and contact layer 45 is performed at 650° C.

On the contact layer 45 is formed an insulating layer 46 having an aperture portion, used in later formation of an Ohmic contact, in the region corresponding to the semiconductor mesa 40a. Using photolithography and lift-off methods, a patterned electrode layer 47 is formed by evaporation deposition (see (g) of FIG. 7). Finally, the rear surface of the substrate 21 is polished, and an electrode layer 48 of thickness 100 μm is formed, to complete the fabrication of the semiconductor laser 50.

As explained in detail above, the semiconductor laser 50 is fabricated using a nanoimprint lithography method. At this time, first the surface of the substrate 20 is covered with a resin 30 which is to become the resin pattern 30A. Then, the mold 10, on the surface opposing the substrate 20 (the main surface) 10a of which are formed a protrusion pattern 12 and spacer portions 14, is pressed against the substrate 20, and the spacer portions 14 make contact with the substrate 20. Further, with the mold 10 pressed against the substrate 20, the resin 30 is hardened, and finally the mold 10 is released from the substrate 20, to obtain a resin pattern 30A.

Because the density of the protrusion pattern 12 of the mold 10 differs in different regions, in the technology of the prior art, it was extremely difficult to achieve uniform loading, so that there was the problem of reduced production yields.

However, by means of the above-described resin pattern formation method, when pressing the mold 10 against the substrate 20, spacer portions 14 higher than the protrusion portion 12 make contact with the substrate 20. Consequently uniform loading can be realized, regardless of the density of the protrusion pattern 12. As a result, the desired resin pattern 30A can be obtained with high precision, and high production yields can be attained.

In addition, because there is no need to cause the protrusion pattern 12 to make contact with the substrate, there is greater freedom in setting the pattern depth. That is, while maintaining a high degree of parallelism by means of the spacer portions 14, patterns shallower than the thickness of the resin 30 can be formed, and patterns of different depths can be formed within the same pattern.

In the above-described aspect, an example was explained in which patterns 12a are arranged at the same intervals of 240 nm; however, application to phase-shift structures and to structures with modulated periods is also possible.

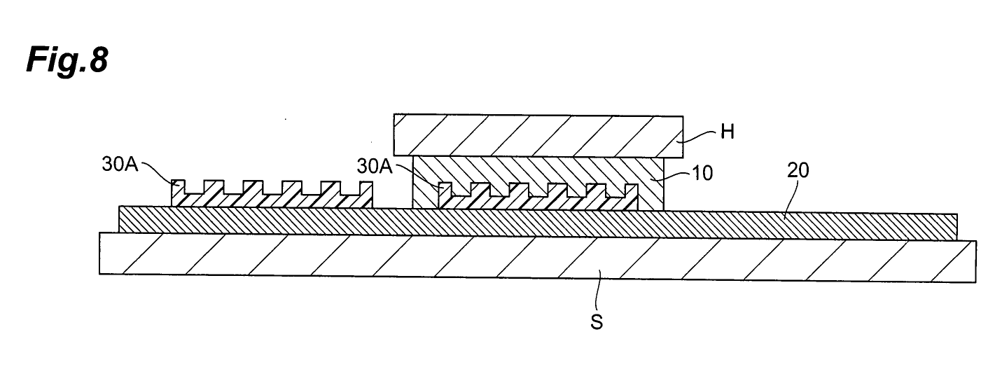

In the above-described aspect, an example was explained in which the dimensions of the mold 10 and the dimensions of the substrate 20 were substantially the same; but as shown in FIG. 8, a mold 10 of small dimensions compared with the dimensions of the substrate 20 may be used, forming resin patterns 30A in a plurality of operations. In cases in which surface depressions and protrusions on the substrate side are large, by such division into small areas when performing imprinting, the effect of depressions and protrusions on the substrate surface is reduced, and more uniform patterns can be obtained.

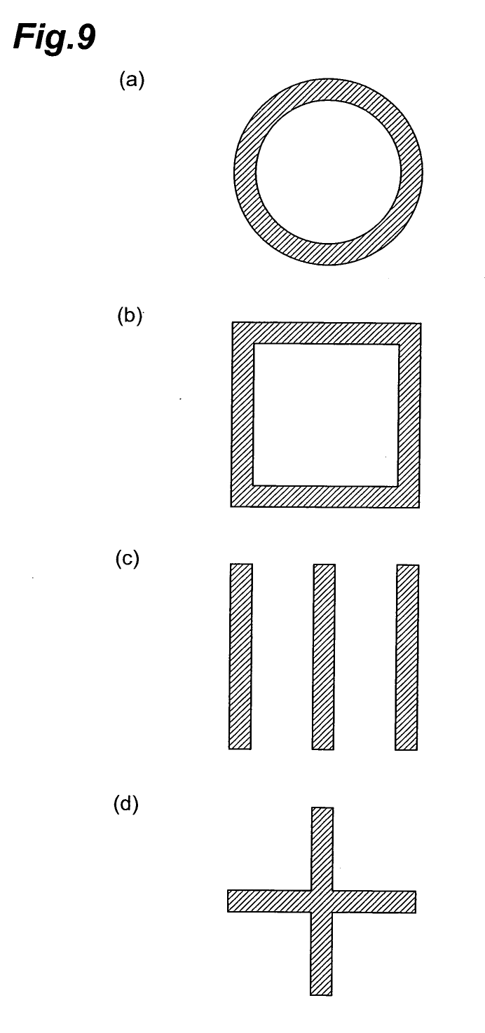

As explained above, in addition to a mode in which a plurality of spacer portions 14 are provided on the periphery of the protrusion pattern 12, modes such as those shown in FIG. 9 may be used. Specifically, the spacer portion 14 may have a circular shape (see (a) in FIG. 9) or a polygonal shape (see (b) in FIG. 9) surrounding the periphery of the protrusion pattern 12. Or, the spacer portion 14 may have the shape of a plurality of slits (see (c) in FIG. 9) or the shape of a cross (see (d) in FIG. 9), so as to be interposed between the regions of formation of a plurality of protrusion patterns 12.

What is claimed is:

1. A resin pattern formation method, in which a resin pattern is formed on a substrate using a nanoimprint lithography method, comprising:
a process of covering the surface of the substrate with a resin which is to become the resin pattern;
a process of pressing a mold, whose surface opposite to the substrate has a protrusion pattern and a spacer portion taller than the protrusion pattern, against the substrate, and bringing the spacer portion into contact with the substrate;
a process of hardening the resin in the state in which the mold is pressed against the substrate; and,
a process of separating the mold from the substrate, to obtain the resin pattern.

2. The resin pattern formation method according to claim 1, wherein a plurality of spacer portions are provided on the periphery of the protrusion pattern.

3. The resin pattern formation method according to claim 1, wherein the spacer portion is provided in an annular shape surrounding the periphery of the protrusion pattern.

4. The resin pattern formation method according to claim 1, wherein a plurality of pattern formation regions in which the protrusion pattern is formed are provided on the mold, and the spacer portion is provided so as to be interposed between the plurality of pattern formation regions.
